(19) United States
(12) Patent Application Publication
(10) Pub. No.: US 2025/0103241 A1
(43) Pub. Date: Mar. 27, 2025

(54) DYNAMIC RAM USING TRIPLE-MODE MEMORY CELL AND ARTIFICIAL INTELLIGENCE ACCELERATOR USING THE SAME

(71) Applicant: Korea Advanced Institute of Science and Technology, Daejeon (KR)

(72) Inventors: Hoi Jun YOO, Daejeon (KR); Sang Jin KIM, Daejeon (KR)

(73) Assignee: Korea Advanced Institute of Science and Technology, Daejeon (KR)

(21) Appl. No.: 18/644,111

(22) Filed: Apr. 24, 2024

(30) Foreign Application Priority Data
Sep. 23, 2023 (KR) 10-2023-0120896

(51) Int. Cl. G06F 3/06

(52) U.S. Cl. CPC G06F 3/0656; G06F 3/0604; G06F 3/0673

(57) ABSTRACT

A DRAM is configured using a triple-mode memory cell that supports a computation mode, a memory mode, and a data conversion mode by one cell and converts modes as necessary, and an AI accelerator using the same is provided, so that a dataflow may be reconfigured according to a structure and a size of an AI neural network (so-called deep neural network) to be trained.

### BACKGROUND OF THE INVENTION

### Field of the Invention

The present invention relates to a dynamic RAM and an artificial intelligence (AI) accelerator using the same, and more particularly to a dynamic random access memory (DRAM) using a triple-mode memory cell (so-called triple-mode cell), and an AI accelerator based on processing-in-memory (hereinafter referred to as PIM) using the same.

### Description of the Related Art

PIM has been studied for a long time, and has an advantage of being able to eliminate energy required to access a weight memory in deep neural network model computation and significantly reduce power consumption required for computation through analog computation, thereby achieving high efficiency when compared to a digital implementation method.

However, while conventional PIM-based processors using such PIM have an advantage of being able to eliminate power consumption of the weight memory and significantly reduce power consumption of a calculator, the conventional PIM-based processors have a problem in that power consumption of an input/output feature map memory, which is a remaining part, cannot be reduced (see Non-Patent Literature 1: Jia, Hongyang, et al., “15.1 a programmable neural-network inference accelerator based on scalable in-memory computing.” 2021 IEEE ISSCC. Vol. 64. IEEE, 2021, Non-Patent Literature 2: S. Yin et al., “A 3.4-MB Programmable In-Memory Computing Accelerator in 28 nm For On-Chip DNN Inference,” IEEE Symp. VLSI Technology, 2021, and Non-Patent Literature 3: K. Ueyoshi et al., “An End-to-End Energy-Efficient Digital and ANAlog Hybrid Neural Network SoC,” ISSCC, pp. 1-3, 2022).

A reason therefor is that the conventional PIM-based processors each use a static core architecture in which sizes of the memory and the calculator inside a core are fixed.

In other words, while a deep neural network includes several layers, and each layer has a different size due to the different number of input/output channels, the conventional PIM-based processors each use the static core architecture in which the sizes of the internal memory and calculator are fixed. Therefore, when computing a layer having a size smaller than a core size, there is a problem that a utilization rate of the calculator decreases, and when computing a layer having a size larger than the core size, data of the corresponding layer needs to be divided and computed to fit the core size. To this end, there is a problem that duplicate data needs to be written in the input/output feature map memory, which increases the amount of memory access.

Accordingly, the conventional PIM-based processor has a problem in that energy efficiency is lowered when computing a layer having a size smaller or larger than the core size, and as a result, energy efficiency is lowered even when accelerating the deep neural network.

Further, to achieve higher efficiency in the PIM-based processors, PIM having a higher degree of integration is required. A reason therefor is that, when the PIM has a high degree of integration, higher parallelism may be exhibited by integrating more memory cells on a chip of the same size, and more reuse is possible by computing data once imported to the chip with more other data.

However, most conventional PIMs have been implemented based on a static RAM (SRAM), and each of the static RAM-based PIMs not only uses six transistors to store data, but also uses additional transistors for computation when implementing one cell. As a result, there is a problem that a degree of integration is lowered. For example, to implement one cell, 10 transistors are used in each of Non-Patent Literature 1 and Non-Patent Literature 2, and 18 transistors are used in Non-Patent Literature 2.

To solve this problem, a DRAM-based PIM that improves a degree of integration by using only a single transistor and capacitor has been developed (see Non-Patent Literature 4: S. Xie et al., “Compute-In-Memory Design with Reconfigurable Embedded-Dynamic-Memory Array Realizing Adaptive Data Converters And Charge-Domain Computing,” ISSCC, pp. 248-249, 2021, Non-Patent Literature 5: S. Xie et al., “CIM: Leakage and Bitline Swing Aware 2T1C Gain-Cell eDRAM Compute in Memory Design with Bitline Precharge DACs and Compact Schmitt Trigger ADCs,” IEEE Symp. VLSI Technology and Circuits, pp. 112-113, 2022, and Non-Patent Literature 6: Z. Chen et al., “65 nm 3T Dynamic Analog RAM-Based Computing-in-Memory Macro and CNN Accelerator with Retention Enhancement, Adaptive Analog Sparsity and 44TOPS/W System Energy Efficiency,” ISSCC, pp. 240-241, 2021). However, there has been a problem of being restricted by limitations of a DRAM. In other words, due to characteristics of the DRAM in which data stored inside the memory is gradually destroyed by leakage current, a computation result of the DRAM-based PIM is affected by leakage current. To solve this problem, conventionally, parallelism of analog operation has been limited so that high-accuracy operation is performed even when leakage current occurs (see Non-Patent Literature 4 and Non-Patent Literature 6), and efforts have been made to reduce effect of leakage current by integrating a large capacitor into each memory cell (see Non-Patent Literature 5). However, in the former case, computational efficiency and area efficiency are low, and in the latter case, there is a problem in that a degree of integration in the memory is low.

Meanwhile, in the existing analog PIM (see Non-Patent Literatures 1 to 6), data formed as analog data during a computation process needs to be stored in a subsequent memory or converted into digital data to be used in subsequent computation. Therefore, the conventional analog PIM adopts an analog-to-digital converter. However, the analog-to-digital converter not only consumes a lot of power but also occupies a large area, which limits performance and efficiency of the PIM-based processor.

### SUMMARY OF THE INVENTION

Therefore, to solve the above-described problems, the present invention provides a DRAM using a triple-mode memory cell and an AI accelerator using the same capable of varying sizes of an internal memory and a calculator according to a structure and a layer of a deep neural network, thereby being able to improve a degree of integration in the memory and area efficiency by providing a DRAM having a high degree of integration using a triple-mode memory cell, and a PIM-based processor having a dynamic core structure that may freely change connection between several memories using the same.

In addition, the present invention provides a DRAM using a triple-mode memory cell and an AI accelerator using the same capable of reconstructing a dataflow according to a structure and size of an AI neural network (so-called deep neural network) to be trained, thereby varying sizes of an internal memory and a calculator according to a structure and a layer of the deep neural network to form a core having a different size suitable for a structure of each layer so that a utilization rate of the calculator and energy efficiency may be improved by configuring a DRAM using a triple-mode memory cell that supports a computation mode, a memory mode, and a data conversion mode by one cell and converts a mode as necessary and providing an AI accelerator using the same.

In addition, the present invention provides a DRAM using a triple-mode memory cell and an AI accelerator using the same capable of reducing area consumption by an analog-to-digital data converter by allowing the area occupied by the analog-to-digital data converter to be reused as a memory by using a triple-mode memory cell structure.

In addition, the present invention provides a DRAM using a triple-mode memory cell and an AI accelerator using the same capable of reducing an operation delay problem caused by refresh by synchronizing refresh of memories operating together through reconstruction of a dataflow.

In addition, the present invention provides a DRAM using a triple-mode memory cell and an AI accelerator using the same capable of reducing power consumption by selectively operating a data converter using a hierarchical internal memory converter.

In addition, the present invention provides a DRAM using a triple-mode memory cell and an AI accelerator using the same capable of improving accuracy of a PIM computation result while maintaining a high degree of integration by limiting a range of voltage used for computation inside a memory cell included in a DRAM to a voltage within a range between the ground voltage and a preset threshold voltage so that leakage current occurring in the DRAM does not affect a PIM computation result.

In addition, the present invention provides a DRAM using a triple-mode memory cell and an AI accelerator using the same capable of reducing a frequency of separate logic operations during actual deep neural network computation using distribution characteristics of input and weight by separately storing sign and magnitude values of input and weight using a 1-bit sign cell and a predetermined-bit magnitude cell and then computing both signs of the input and weight in a memory, thereby being able to reduce energy consumption.

In accordance with an aspect of the present invention, the above and other objects can be accomplished by the provision of a dynamic random access memory (DRAM) using a triple-mode memory cell including a switchable PIM array including a plurality of triple-mode memory cells each operating in any one operation mode among a computation mode, a memory mode, and a data conversion mode, a reconfigurable memory unit configured to operate as a computation control module for supporting a computation function or a buffer for data buffering depending on the operation mode of each of the memory cells, and a memory controller configured to determine the operation mode of each of the memory cells by external control, wherein the DRAM memory is convertible to any one of a calculator, a memory, and a data converter.

In accordance with another aspect of the present invention, there is provided an artificial intelligence (AI) accelerator configured to train an AI neural network, the AI accelerator including a plurality of fixed memories exclusively operating as memories, a plurality of switchable memories each switchable to any one of a calculator, a memory, and a data converter, a plurality of transmission links configured to connect dataflows between the fixed memories and the switchable memories so that the dataflows are reconfigurable, and a dynamic core generator configured to determine fixed memories and switchable memories to participate in training and an operation mode of each of the switchable memories to participate in training based on a structure and size of the AI neural network, and then reconfigure the dataflow according to a result thereof to generate a dynamic core.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a schematic block diagram of an AI accelerator according to an embodiment of the present invention;

FIG. 2 is a diagram for describing an example of a dataflow network and a memory structure of the AI accelerator illustrated in FIG. 1;

FIG. 3 is a diagram illustrating a structure of each of fixed memories integrated inside the AI accelerator illustrated in FIG. 1;

FIG. 4 is a diagram illustrating a structure of each of switchable memories integrated inside the AI accelerator illustrated in FIG. 1;

FIG. 5 is a diagram illustrating a structure of a switchable PIM array integrated inside the switchable memory illustrated in FIG. 4;

FIG. 6 is a diagram illustrating structures of a sign cell and a magnitude cell included in a unit of computation of the switchable PIM array illustrated in FIG. 5;

FIG. 7 is a diagram for describing a specific operation according to an operation mode of the unit of computation illustrated in FIG. 6;

FIG. 8 is a diagram for describing a structure and an operation state for each operation mode of each of the switchable memories illustrated in FIG. 4;

FIGS. 9A and 9B are diagrams for describing a computation process of the switchable PIM array illustrated in FIG. 5;

FIG. 10 is a diagram for describing a leakage current tolerant computation method applied to the computation process of the switchable PIM array illustrated in FIG. 9;

FIG. 11 is a diagram illustrating a structure of a hierarchical internal memory converter implemented in the switchable PIM array illustrated in FIG. 5;

FIG. 12 is a diagram for describing an operation of the hierarchical internal memory converter illustrated in FIG. 11;

FIG. 13 is a diagram for describing a method of controlling refresh of the switchable memories according to an operation in the memory structure of the AI accelerator as illustrated in FIG. 2;

FIG. 14 is a diagram illustrating a structure of a refresh controller according to an embodiment of the present invention;

FIGS. 15 and 16 are diagrams for describing a method of generating a dynamic core architecture by a dynamic core generator illustrated in FIG. 1; and

FIG. 17 is a diagram for describing a structure and an operation of a dataflow network reconfigured by the dynamic core generator illustrated in FIG. 1.

### DETAILED DESCRIPTION OF THE INVENTION

Hereinafter, the present invention will be described in detail with reference to the attached drawings so that those skilled in the art to which the present invention pertains may easily practice the present invention.

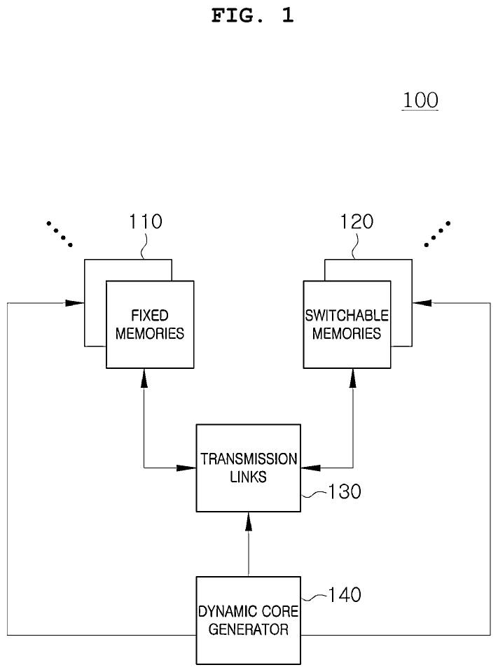

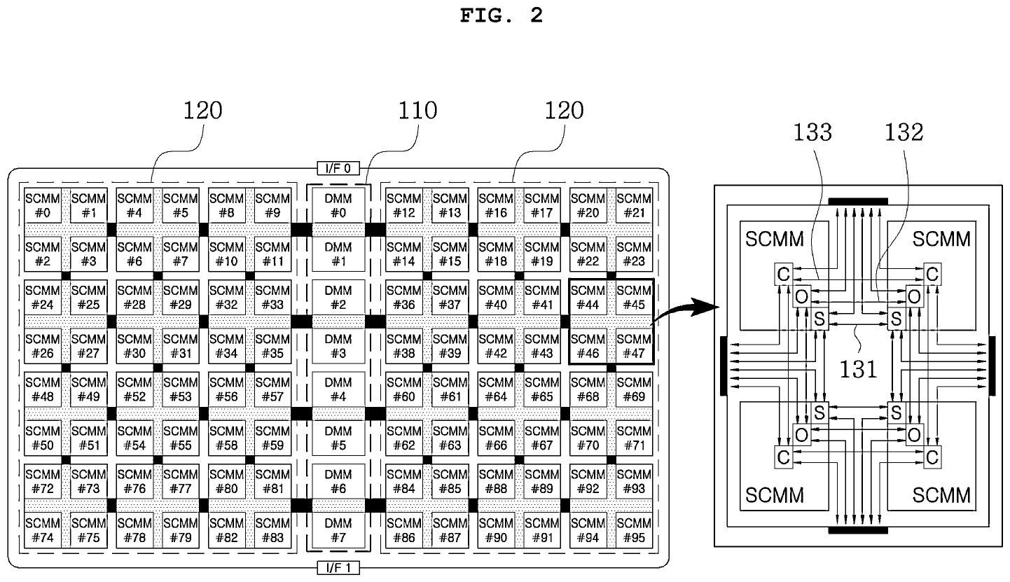

FIG. 1 is a schematic block diagram of an AI accelerator according to an embodiment of the present invention, and FIG. 2 is a diagram for describing an example of a dataflow network and a memory structure of the AI accelerator illustrated in FIG. 1. In particular, FIG. 2 is an example of a memory structure of a reconfigurable PIM-based AI accelerator, and illustrates an example in which 8*12 switchable memories SCMM and 8*1 fixed memories DMM are configured as an array.

Referring to FIGS. 1 and 2, the AI accelerator 100 according to the embodiment of the present invention includes a plurality of fixed memories 110, a plurality of switchable memories 120, a plurality of transmission links 130, and a dynamic core generator 140.

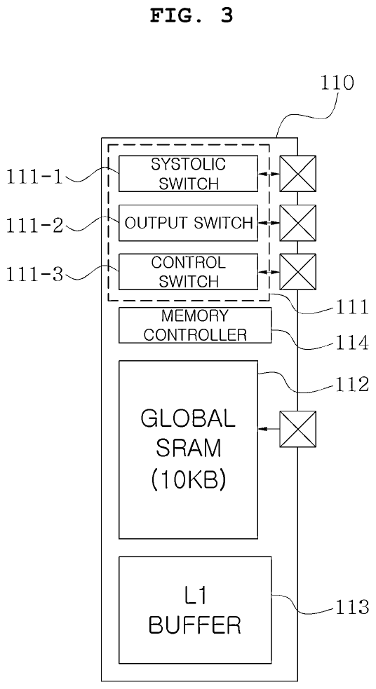

The fixed memories 110 refer to memories operating only as memories, are implemented as DRAMs, and may be disposed in a center of the memory structure of the AI accelerator as illustrated in FIG. 2. A structure of each of the fixed memories 110 is illustrated in FIG. 3, and a specific structure of the fixed memory 110 will be described later with reference to FIG. 3.

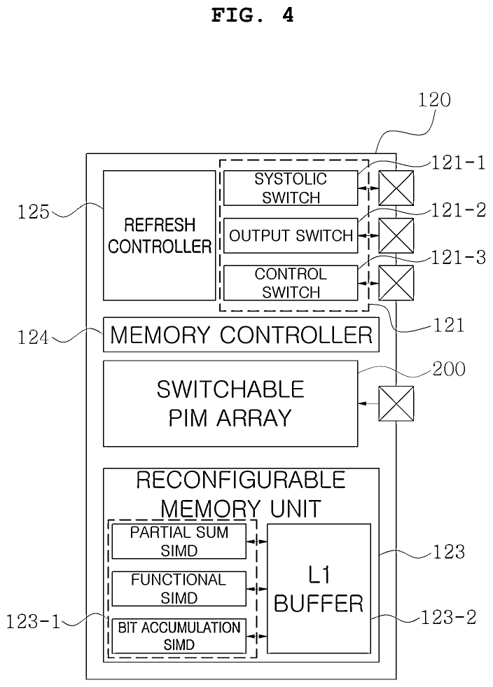

The switchable memories 120 refer to memories that may be switched to any one of a calculator, a memory, and a data converter, and may be implemented as DRAMs and disposed on both sides of the fixed memories 110 as illustrated in FIG. 2. A structure of each of the switchable memories 120 is illustrated in FIG. 4, and a specific structure of the switchable memory 120 will be described later with reference to FIG. 4.

The transmission links 130 connect dataflows between the fixed memories 110 and the switchable memories 120 so that the dataflows are reconfigurable. To this end, the transmission links 130 may include a systolic link S 131 that moves input for computation or a computation partial sum result, an output link 0 132 for output of computed data, and a control link C 133 for transmission of a control signal necessary to reconfigure the structure of the AI accelerator 100 (for example, a memory synchronization signal necessary to synchronize a plurality of memories during computation, a refresh signal necessary to control refresh, etc.), and one of the systolic link S 131 and the output link O 132 may be activated to form a dataflow between the corresponding memories depending on the operation mode of each memory.

In this instance, the “dataflow” refers to a path for transmission of data between the memories (that is, the fixed memories 110 and the switchable memories 120), and depending on the layer and size of an AI neural network (that is, deep neural network) to be trained, the transmission links 130 connected between memories (that is, the fixed memories 110 and the switchable memories 120), each of which is selected to operate as a memory or a calculator, may be activated and generated.

That is, the transmission links 130 may be connected to be able to reconstruct the dataflow under the control of the dynamic core generator 140 to be described later.

The dynamic core generator 140 generates a dynamic core by reconfiguring the dataflow based on the structure and size of the AI neural network to be trained, and may select fixed memories 110 and switchable memories 120 to participate in training, determine an operation mode of each of the switchable memories 120 among the selected memories 110 and 120, and then reconfigure the dataflow to generate a dynamic core according to a result thereof.

For example, the dynamic core generator 140 determines the number of memories 110 and 120 to participate in training based on the structure and size of the AI neural network to be trained, and selects necessary memories 110 and 120 among the memories disposed in the structure illustrated in FIG. 2 according to the number. Further, the dynamic core generator 140 determines an operation mode of each of the switchable memories 120 among the selected memories 110 and 120, and then activates the transmission links between the selected memories 110 and 120 according to a result thereof. In this instance, the dynamic core generator 140 may form a dataflow by activating the systolic link S 131 between the switchable memories 120 selected to operate as calculators and activating the output link O 132 between the switchable memories 120 and the fixed memories 110 selected to operate as memories.

As described above, the present invention may freely vary the number of memories to participate in training and the dataflow therebetween based on the structure and size of the AI neural network (that is, deep neural network) to be trained to vary the sizes of the internal memory and the calculator according to the structure and layer of the AI neural network (that is, deep neural network), thereby forming a core of a different size suitable for the structure of each layer. That is, the AI accelerator 100 of the present invention may perform spatial reconfiguration based on DRAM-PIM.

Accordingly, the present invention has an advantage of improving the degree of integration in the memory and area efficiency and improving a utilization rate of the calculator and energy efficiency in the AI accelerator 100 based on DRAM-PIM.

FIG. 3 is a diagram illustrating a structure of each of the fixed memories integrated inside the AI accelerator illustrated in FIG. 1. Referring to FIGS. 1 to 3, the fixed memory 110 according to an embodiment of the present invention includes a link switch 111, a global SRAM (static RAM) 112, an L1 buffer 113, and a memory controller 114.

The link switch 111 controls formation of a dataflow between at least one of different fixed memories 110 and at least one of the switchable memories 120 under the control of the dynamic core generator 140. To this end, the link switch 111 may include a systolic switch 111-1 for connection to the systolic link S 131, an output switch 111-2 for connection to the output link O 132, and a control switch 111-3 for connection to the control link C 133.

The global SRAM (static RAM) 112 stores data necessary for training. To this end, the global SRAM (static RAM) 112 may be implemented to have a capacity of 10 kB.

The L1 buffer 113 buffers input/output data of the global SRAM 112.

The memory controller 114 generates and outputs a control signal to control the operation of the fixed memory 110.

FIG. 4 is a diagram illustrating a structure of each of the switchable memories integrated inside the AI accelerator illustrated in FIG. 1. Referring to FIGS. 1 to 4, each of the switchable memories 120 according to an embodiment of the present invention includes a link switch 121, a switchable PIM array 200, a reconfigurable memory unit 123, a memory controller 124, and a refresh controller 125.

The link switch 121 controls formation of a dataflow between at least one of different memories 120 and at least one of the fixed memories 110 under the control of the dynamic core generator 140. To this end, the link switch 121 may include a systolic switch 121-1 for connection to the systolic link S 131, an output switch 121-2 for connection to the output link O 132, and a control switch 121-3 for connection to the control link C 133.

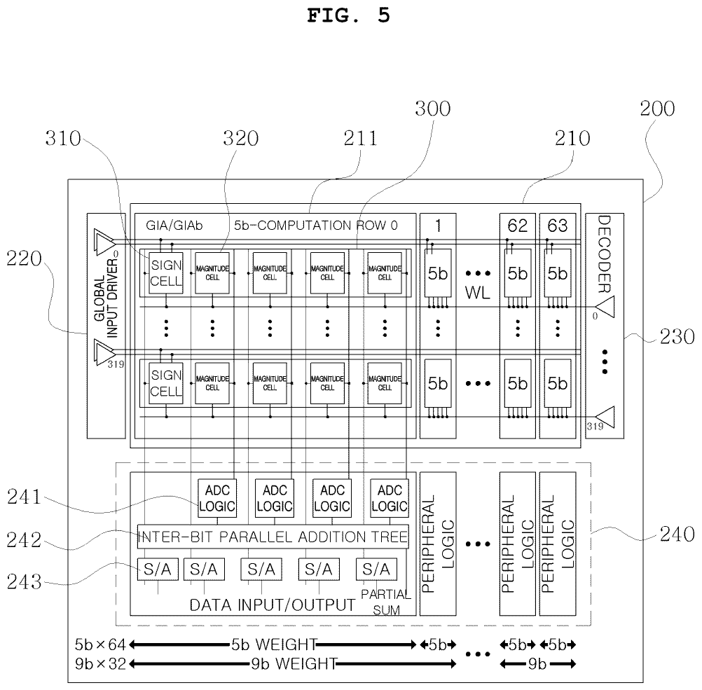

The switchable PIM array 200 includes a plurality of triple-mode memory cells, and the triple-mode memory cells may operate in any one of operation modes among a computation mode, a memory mode, and a data conversion mode. A structure and a function of the switchable PIM array 200 will be described in detail with reference to FIGS. 5 to 12.

The reconfigurable memory unit 123 operates as one of a computation control module 123-1 for supporting a computation function or a buffer (L1 buffer) for data buffering according to an operation mode of the memory cell (that is, triple-mode memory cell), and the computation control module 123-1 may include partial sum SIMD (Single Instruction Multiple Data), functional SIMD, and bit accumulation SIMD. In this instance, the bit accumulation SIMD performs accumulation computation necessary to process multi-bit input, and the partial sum SIMD allows accumulation of computation results between several memory arrays. Meanwhile, the functional SIMD supports computation such as normalization, activation function, and quantization incidental to deep neural network computation. In addition, the functional SIMD may change an object of the switchable memory 120 (for example, calculator or memory) by switching modes of the switchable PIM array 200 and the reconfigurable memory unit 123.

The memory controller 124 generates and outputs a control signal to control the operation of the switchable memory 120. In particular, the memory controller 124 may determine the operation modes of the memory cells by control of the dynamic core generator 140.

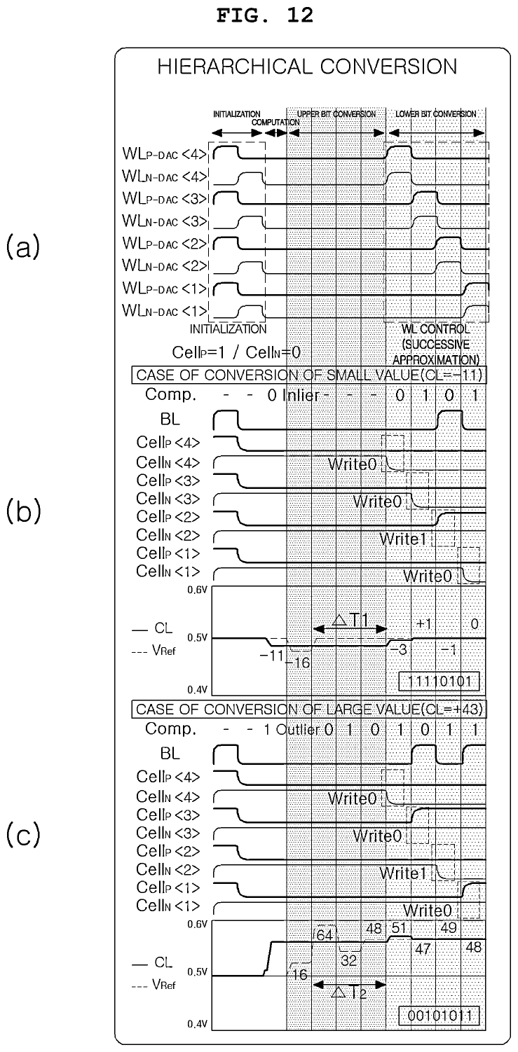

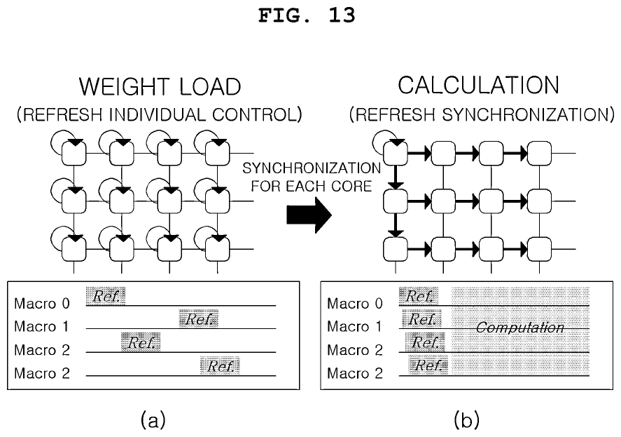

When the switchable memory 120 operates as a calculator, the refresh controller 125 performs a control operation so that a refresh cycle is the same as that of other switchable memories 120 forming a dataflow. A control method and structure of the refresh controller 125 will be described in detail with reference to FIGS. 13 and 14.

FIG. 5 is a diagram illustrating a structure of the switchable PIM array 200 integrated inside the switchable memory illustrated in FIG. 4. Referring to FIGS. 1 to 5, the PIM array 200 includes a memory cell array 210, a global input driver 220, a decoder 230, and peripheral logic 240.

The memory cell array 210 is implemented as an array of a plurality of DRAM memory cells (that is, triple-mode cells), and may include a plurality of computation rows 211 each formed in a unit of computation 300 including a 1-bit memory cell (so-called “sign cell”) indicating sign and a predetermined-bit memory cell (so-called “magnitude cell”) indicating magnitude to process signals of certain bits by separation into sign and magnitude. FIG. 5 illustrates an example in which the memory cell array 210 includes 64 5b-computation rows 300, and each of the 5b-computation rows 300 is configured in a size of 320×320 by including one row of sign cells 310 and four rows of magnitude cells 320.

In this instance, one 5b-computation row 300 supports computation on a 5-bit weight. However, in the case of a highly complex neural network, two 5b-computation rows 300 may be combined to compute a 9b weight.

The global input driver 220 transmits input required for computation to the memory cell array 210. In particular, the global input driver 220 transmits input data or a control signal for determining the operation modes of the memory cells to the memory cell array 210.

The decoder 230 reads data stored in the memory cell array 210, and analyzes and decodes the data.

The peripheral logic 240 includes ADC logic 241, an inter-bit parallel addition tree 242, and a sensor/amplifier (S/A) 243 to control the operation of the memory cell array 210, and is responsible for interfacing with external devices.

In particular, to prevent leakage current occurring in memory cells included in the memory cell array 210 from affecting the PIM computation result, the peripheral logic 240 may limit a range of voltage used for computation inside the memory cells to a voltage within a range between the ground voltage and a preset threshold voltage. For example, the peripheral logic 240 may limit the range of voltage used for computation inside the memory cells to 0 V to 0.7 V.

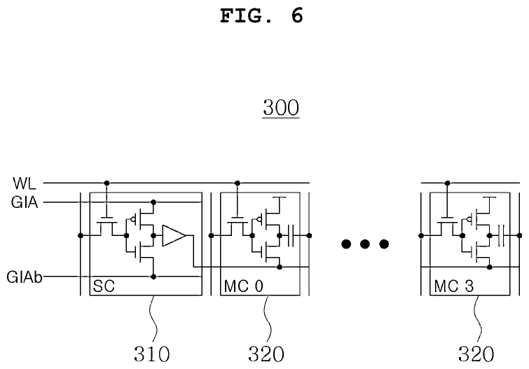

FIG. 6 is a diagram illustrating structures of the sign cell and the magnitude cell included in a unit of computation of the switchable PIM array illustrated in FIG. 5, and structures of a sign cell 310 and a magnitude cell 320 included in the unit of computation 300 will be described as below with reference to FIGS. 5 and 6.

First, the sign cell SC 310 includes a first transistor turned on/off in response to a signal of a word line WL to transmit a signal of a bit line into the sign cell SC 310, a first inverter formed by a plurality of transistors connected in series between a pair of global input signals GIA and GIAb input through the global input driver 220, and an amplifier connected to an output terminal of the first inverter, and outputs a local input signal for determining an operation mode of a corresponding magnitude cell by the pair of global input signals GIA and GIAb. To this end, the sign cell SC 310 may store a weight sign in advance.

The magnitude cell MC 320 includes a second transistor turned on/off in response to a signal of the word line WL to transmit a signal of the bit line into the magnitude cell MC 320, a second inverter formed by a plurality of transistors connected in series between a power supply voltage and the local input signal, and a capacitor connected to an output terminal of the second inverter. In this instance, the second inverter may operate as any one of a multiplier, a capacitor, or a data converter by the local input signal. An example of FIG. 6 illustrates an example in which four magnitude cells MC 320 are configured to process a 4-bit signal.

For example, when sign and magnitude of input data are transmitted through the global input driver 220, the sign cell SC 310 multiplies the weight sign by the sign of the input data to output a computation mode local input signal for operating the corresponding magnitude cells MC 320 in the computation mode, and the magnitude cells MC 320 may operate as a 1-bit multiplier in response to the computation mode local input signal.

Meanwhile, when the pair of global input signals GIA and GIAb is both 1, the sign cell SC 310 outputs a memory mode local input signal for operating the corresponding magnitude cells MC 320 in the memory mode, and the magnitude cells MC 320 may operate as a MOS capacitor in response to the memory mode local input signal.

In addition, when the pair of global input signals is both 0, the sign cell SC 310 outputs a data conversion mode local input signal for operating the corresponding magnitude cells MC 320 in the data conversion mode, and the magnitude cells MC 320 may operate as a unit DAC including a capacitor and an inverter in response to the data conversion mode local input signal.

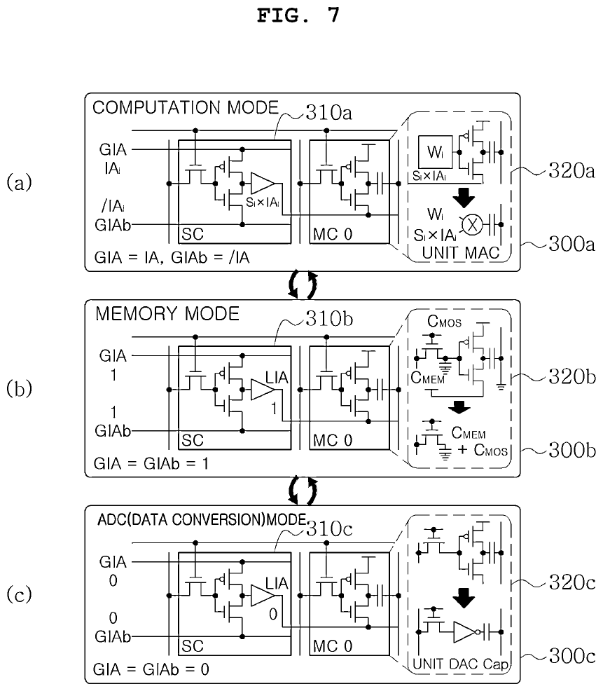

FIG. 7 is a diagram for describing a specific operation according to an operation mode of the unit of computation illustrated in FIG. 6. FIG. 7A illustrates an example in which the unit of computation operates in a computation mode 300a, FIG. 7B illustrates an example in which the unit of computation operates in a memory mode 300b, and FIG. 7C illustrates an example in which the unit of computation operates in an ADC (data conversion) mode 300c. In this instance, the operation of the unit of computation may be determined by the operation mode of the magnitude cell 320 (that is, triple-mode cell) included in the unit of computation, and the operation mode of the magnitude cell 320 (that is, triple-mode cell) may be determined by global input control in the global input driver 220 and the operation of the sign cell 310 accordingly.

A specific operation of the unit of computation 300 according to each operation mode is as follows.

First, referring to FIG. 7A computation using PIM is supported in the computation mode 300a. In this instance, the global input driver 220 inputs sign and magnitude values of input to a sign cell SC 310a through a pair of global input lines GIA and GIAb. Then, a local input line is determined by a multiplication result of the input and weight sign, and each magnitude cell MC 320a operates as a 1-bit multiplier by the local input line.

Meanwhile, referring to FIG. 7B, in the memory mode 300b, a computation circuit of the magnitude cell MC 320b is deactivated. Therefore, to fix the local input line LIA to 1, the pair of global input lines GIA and GIAb is both set to 1. In this case, as a result, a transistor of the magnitude cell MC 320b is turned off and each magnitude cell MC 320a operates as a MOS capacitor. In this instance, the capacitor may increase capacitance of a cell storage node.

Further, in the data conversion mode 300c, the pair of global input lines GIA and GIAb is both set to 0 and the local input line LIA is set to 0. Then, a computation circuit of a magnitude cell MC 320c operates as a unit DAC including an inverter having a capacitor, which may be used to configure an ADC.

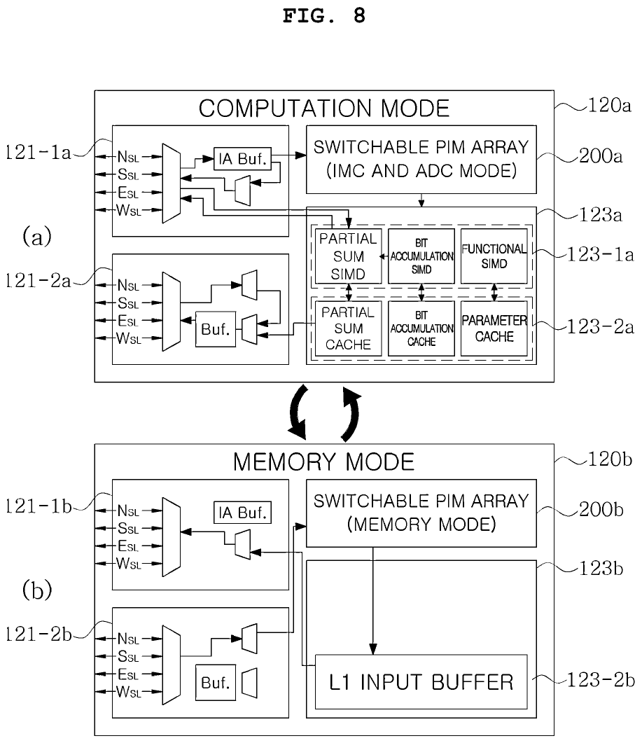

FIG. 8 is a diagram for describing a structure and an operation state for each operation mode of each of the switchable memories illustrated in FIG. 4. Referring to FIGS. 4 and 8, the switchable memory 120 may operate in a computation mode 120a or a memory mode 120b, and mode switching of the switchable memory 120 may be supported by switching the mode of the switchable PIM array 200 and switching a data path of the reconfigurable memory unit 123.

When the switchable memory is in the computation mode 120a, a switchable PIM array 200a is configured in a computation and data-conversion mode for matrix-vector multiplication, and the reconfigurable memory unit 123 is used as an SIMD for multi-bit input computation, partial sum accumulation, and functional computation (normalization, activation function, and quantization).

On the other hand, when the switchable memory is in the memory mode 120b, a switchable PIM array 200b is configured in the memory mode, and the reconfigurable memory unit 123 is used as an L1 input buffer for input reuse and input sorting during convolution computation.

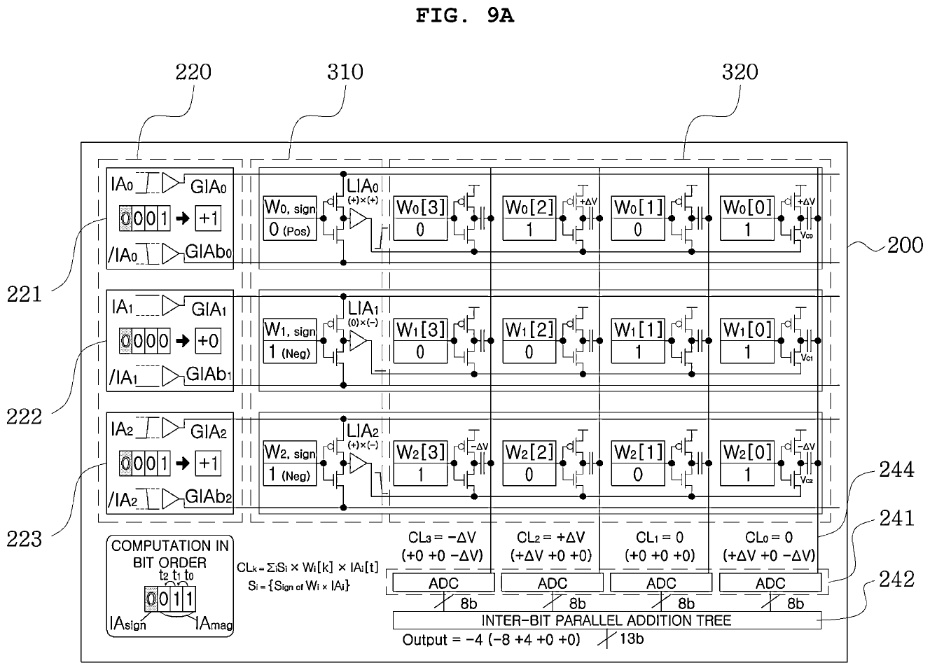

FIGS. 9A and 9B are diagrams for describing a computation process of the switchable PIM array illustrated in FIG. 5, and illustrates a process of computing both signs of input and weight (that is, encoding-input and encoding-weight computation) in the switchable PIM array 200. The computation process of the switchable PIM array will be described as follows with reference to FIGS. 5, 9A, and 9B.

First, the global input driver 220 determines a direction of a rising/falling signal transmitted to the pair of global input lines GIA and GIAb according to the sign of the input, and determines whether to transmit a signal according to a magnitude bit value (that is, whether the magnitude bit value is 1 or 0). In addition, the sign of the weight is stored in the sign cell 310. According to this sign, a direction of a signal input from the pair of global input lines GIA and GIAb is changed, and the signal is transmitted to the local input line LIA. An example in which the local input line LIA is determined by magnitude IAmag and sign IAsign of the input signal and the pair of global input lines GIA and GIAb is illustrated in FIG. 9B.

In addition, the local input line LIA charges only a capacitor inside the magnitude cell 320 that stores 1 and performs multiplication computation, and accordingly, a voltage of a computation line 244 is formed as a computation result for each bit, which may be converted into a hierarchical internal memory converter 400, which will be described later, and added to an inter-bit parallel addition tree 209 to form final output.

As such, the present invention separately stores the signs and magnitude values of the input and weight using the 1-bit sign cell and the predetermined-bit magnitude cell, and then computes both the signs of the input and the weight inside the memory, so that a frequency of logic operating separately during actual deep neural network computation may be reduced using distribution characteristics of the input and the weight. In this way, energy consumption may be reduced.

In addition, in the process of performing multiplication computation in the magnitude cell 320 described above, a leakage current tolerant computation method is used. To this end, as described above, to prevent leakage current from affecting the computation result, the peripheral logic 240 limits a range in which the sign cell 310 operates the voltage of the local input line LIA to a voltage within the range between the ground voltage and the preset threshold voltage. For example, the peripheral logic 240 may limit a range of voltage used for computation within the memory cell to 0 V to 0.7 V.

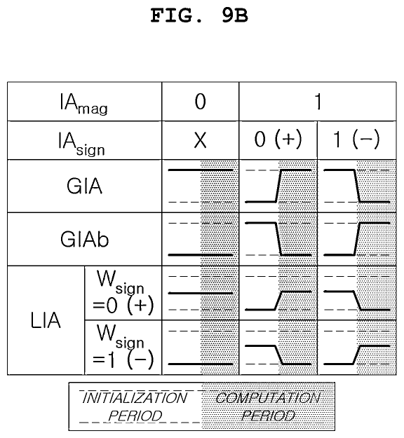

A reason therefor is that, as illustrated in FIG. 10, when the voltage used for computation inside the memory cell is within the range of 0 V to 0.7 V, even if leakage current occurs, the voltage of the local input line LIA is formed to be lower than the voltage inside the cell at all times, and thus an influence of leakage current may be eliminated.

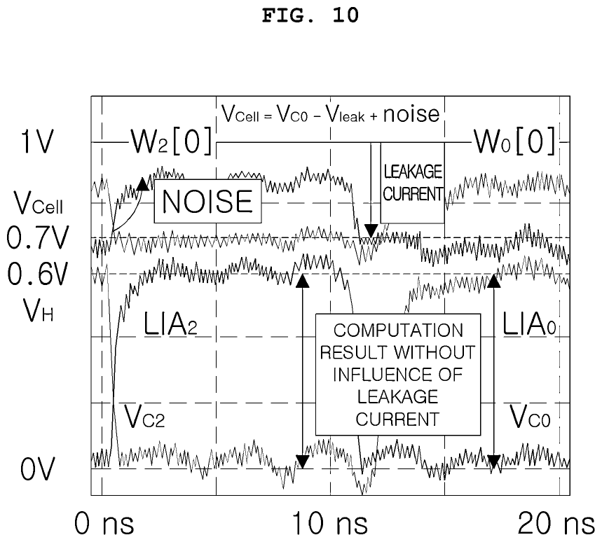

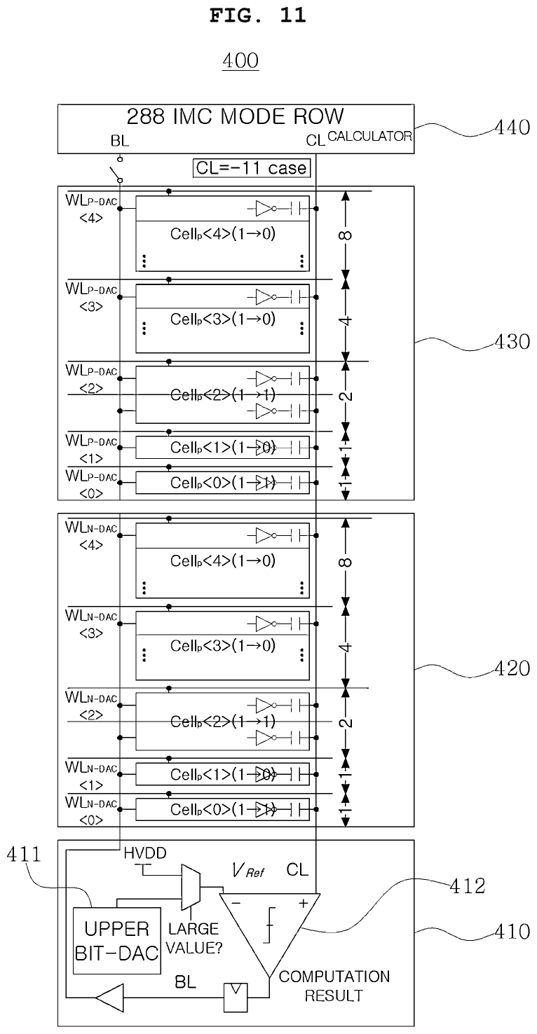

FIG. 11 is a diagram illustrating a structure of a hierarchical internal memory converter implemented in the switchable PIM array illustrated in FIG. 5, and FIG. 12 is a diagram for describing an operation of the hierarchical internal memory converter illustrated in FIG. 11. A structure and an operation of a hierarchical internal memory converter 400 will be described as follows with reference to FIGS. 5, 11, and 12.

First, the hierarchical internal memory converter 400 includes an external upper bit-ADC 410, a negative lower bit DAC 420, a positive lower bit DAC 430, and a 288 IMC mode row calculator 440.

The external upper bit-ADC 410 includes the ADC logic 241 inside the peripheral logic 240, and detects upper 4 bits including a sign bit so that area efficiency is maintained while increasing memory density.

Meanwhile, the negative lower bit DAC 420 and the positive lower bit DAC 430 each use a triple-mode cell to detect lower 4 bits and include 16 rows, which are divided into groups of 8 rows, 4 rows, 2 rows, 1 row, and 1 row. In this instance, word lines of each group are processed by the same shared control signal.

To this end, the memory controller 124 of FIG. 4 first controls a computation row (hereinafter referred to as “first computation row”) including an arbitrary memory cell (hereinafter referred to as “first memory cell”) operating in a computation mode and an arbitrary memory cell (hereinafter referred to as “second memory cell”) operating in an ADC mode so that a computation result of the first memory cell, as disclosed in the description with reference to FIG. 9A and FIG. 9B, is generated as an analog voltage on a computation line CL.

In addition, the memory controller 124 controls the analog-to-digital converter 400 in the hierarchical memory constructed using the second memory cells and the upper bit-ADC 410 so that an analog voltage of the computation line CL is converted into a digital voltage, controls the word line and the bit line applied to the first computation row so that a digital signal is recorded in each of the second memory cells, and connects output of each of the second memory cells to the internal computation line CL to convert a digital signal into an analog signal while changing a value of the computation line using a sequential comparison method, thereby performing a control operation to detect the analog voltage.

In an example of FIG. 11, one computation row includes 320 memory cells and the upper bit-ADC 410, and lower 32 memory cells among the 320 memory cells are included in a lower bit-ADC cell. In addition, the upper bit-ADC and the lower bit-ADC convert an upper bit and a lower bit, respectively, and are included in the analog-to-digital converter 400 inside the entire hierarchical memory.

Meanwhile, 288 memory cells, excluding the lower 32 cells among the 320 memory cells, are included in the IMC mode row calculator 440 for computation, and are configured through the magnitude cell 320 described with reference to FIGS. 5, 6, and 9.

Therefore, when a computation result in the IMC mode row calculator 440 is generated as an analog voltage on the computation line CL, the analog-to-digital converter 400 in the hierarchical memory may obtain a computation result as a digital value through conversion into the digital value.

Meanwhile, the memory controller 124 of FIG. 4 stores in advance a reference value for determining whether to use an external converter (that is, external upper bit-ADC) 410, and when the input data exceeds the reference value, upper bits on the most significant bit (MSB) side of the input data are converted by the external converter, and the analog-to-digital converter may be allowed to convert only lower bits on the least significant bit (LSB) side of the input data.

In this way, with regard to the hierarchical internal memory converter 400 of the present invention, a method of dividing bits into upper bits and lower bits to hierarchically converting the bits into digital values has an advantage of reducing power consumption since the operation of the upper bit-ADC 410 may be skipped when the computation result on the computation line CL is a small value that may be expressed using only lower bits.

In addition, the lower bit-ADC requires a positive part-DAC and a negative part-DAC including memory cells to be implemented inside the memory, which requires a large area. However, the hierarchical internal memory converter 400 of the present invention does not implement both the upper bit-converter and the lower bit-converter inside the memory, implements only the lower bit-converter inside the memory, and uses an external ADC as the upper bit-converter, thereby having an advantage of reducing the ADC area.

In other words, the operation of the hierarchical internal memory y converter 400 includes four steps of initialization, computation, upper bit conversion, and lower bit conversion. In the initialization step, the positive part DAC 430 and the negative part DAC 420 are initialized to 1 and 0, respectively.

In the computation step, the memory cells of the IMC mode row calculator 440 perform computation as described in FIG. 9 to generate an analog voltage corresponding to the computation result on the computation line CL.

Further, in the upper bit conversion and lower bit conversion steps, a computation result formed as an analog voltage on the computation line CL is converted into a digital value using a sequential comparison analog-to-digital conversion method. In this instance, in the upper bit conversion step, an upper bit of a value to be converted is detected and converted, and in the lower bit conversion step, the remaining lower bits are converted. In the described implementation example, 4 bits of data including a sign are converted in the upper bit conversion step and 4 bits of data are converted in the lower bit conversion step.

Meanwhile, in the case of a small value between −15 and 15, which is a value expressible only by lower bits without using upper bits, as in the example where a value of the computation line CL is −11, upper bit conversion is unnecessary, and thus the hierarchical internal memory converter 400 skips upper bit conversion. On the other hand, when a value of the computation line CL is a large value of (<−15 or >15), as in the example of +43, upper bit conversion is performed. For the operation of the lower bit-ADC, upper bit conversion is performed in the external upper bit-ADC 410, and then a reference voltage Vref is formed. In addition, upper bit conversion uses the sequential comparison analog-to-digital conversion method. To this end, a voltage generated by an upper bit-DAC 411 is compared with a voltage of the computation line CL using a comparator 412, and conversion may be performed using a binary search method by controlling the upper bit DAC-411.

Thereafter, each group of a positive part-DAC 430 and a negative part-DAC 420 is activated sequentially from cell to cell for lower bit conversion using the sequential comparison analog-to-digital conversion method. In this instance, when a result obtained by comparing the reference voltage Vref generated by the upper bit-ADC 410 with the computation line CL using the comparator 412 in the upper bit-ADC 410 is applied to a bit line BL, a comparison result is recorded inside a cell corresponding to an activated group (one of the cells) inside the positive part-DAC 430 and the negative part-DAC 420. In this case, only one of 1 or 0 is applied to the bit line BL depending on the comparison result. However, since initial internal cell values of the positive part-DAC 430 and the negative part-DAC 420 are opposite values of 1 and 0, respectively, an internal cell value of only one DAC changes depending on the comparison result. That is, when the voltage of the computation line CL is greater than the reference voltage Vref, 1 is applied to the bit line, and only the negative part-DAC 430 changes the internal cell value from 0 to 1 to lower the voltage of the computation line CL. Conversely, when the voltage of the computation line CL is less than the reference voltage Vref, 0 is applied to the bit line, and only the positive part-DAC 430 changes the internal cell value from 1 to 0 to increase the voltage of the computation line CL.

Meanwhile, the amount by which the positive part-DAC 430 and the negative part-DAC 420 change the voltage of the computation line CL is proportional to the number of cells within the activated group. Each group of the positive part-DAC 430 and the negative part-DAC 420 includes numbers corresponding to powers of 2, such as 8, 4, 2, and 1.

Therefore, the voltage of the computation line CL is increased or decreased by the magnitude of 8, 4, 2, and 1 while being repeatedly compared with the reference voltage Vref generated by the upper bit-DAC 411 in the upper bit-ADC 410. As a result, the voltage converges to the reference voltage Vref using a binary search method and is converted to a digital value. Therefore, the lower bit-ADC performs lower bit conversion using the sequential comparison analog-to-digital conversion method.

FIG. 13 is a diagram for describing a method of controlling refresh of the switchable memories according to an operation in the memory structure of the AI accelerator as illustrated in FIG. 2, and illustrates a method of controlling refresh required for a DRAM when using a plurality of switchable memories 120 by using a reconfigurable, dynamic core architecture 300. That is, as illustrated in FIG. 13A, when several switchable memories 120 do not operate together (for example, weight load, etc.), the refresh controller 125 separately refreshes each memory using an individual control method, and as illustrated in FIG. 13B, when several memories operate together (for example, calculation is performed using a reconfigurable dynamic core architecture, etc.), the several memories are simultaneously refreshed using a refresh synchronization method.

This is implemented through a refresh network connected to a refresh switch included in each of the several memories, the refresh switch is included in the refresh controller 125 illustrated in FIG. 4, and an example of a structure thereof is illustrated in FIG. 14.

FIG. 14 is a diagram illustrating a structure of a refresh switch according to an embodiment of the present invention. Referring to FIG. 14, the refresh switch 500 according to an embodiment of the present invention includes a refresh signal input unit 520, a refresh signal output unit 530, and a refresh monitoring unit 540. The refresh signal input unit 520 is connected to the refresh signal output unit 530 in another memory array in north, south, east, and west directions of each memory, and the refresh monitoring unit 540 records a time required since the most recent refresh to compare the time with a maintainable time, thereby verifying whether refresh is necessary. The refresh of each memory is determined through either a peripheral memory in the north, south, east, and west directions, or a self-refresh monitoring unit through the refresh signal input unit 520 or the refresh monitoring unit 540 according to predetermined setting. Accordingly, the refresh individual control method (FIG. 13A) or the refresh synchronization method (FIG. 13B) may be used as needed.

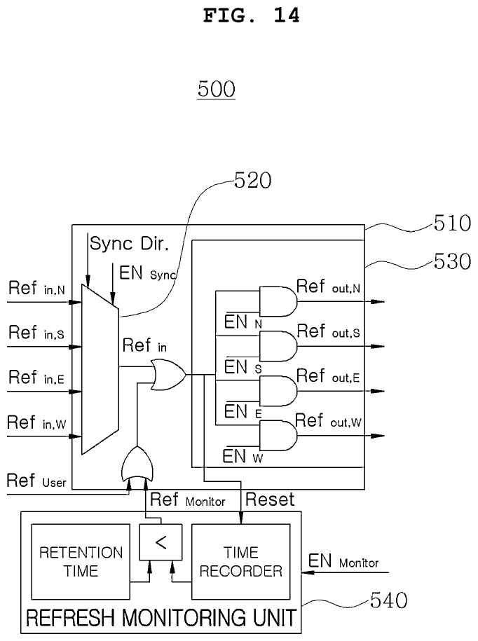

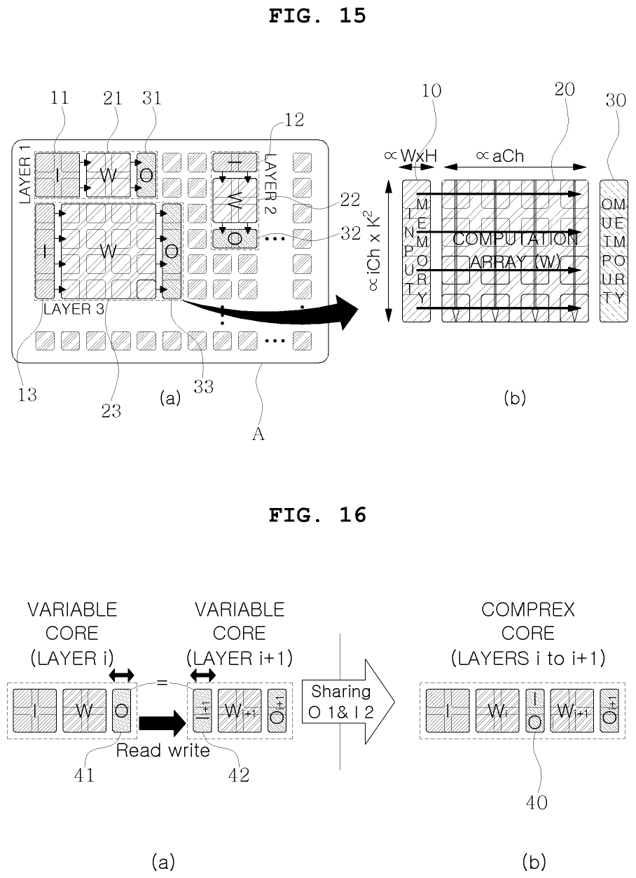

FIGS. 15 and 16 are diagrams for describing a method of generating a dynamic core architecture by the dynamic core generator illustrated in FIG. 1. FIG. 15 illustrates a dynamic core integration method, and FIG. 16 illustrates a dynamic core combination method. In this instance, both of the above methods are intended to reduce input/output memory access and memory capacity requirements. The dynamic core integration method (see FIG. 15) reduces memories through optimization in a deep neural network layer, and the dynamic core combination method (see FIG. 16) reduces memories through optimization between layers when using several layers.

First, referring to FIGS. 1 and 15, the dynamic core generator 140 determines the number of switchable memories to participate in training based on a structure and size of a first AI neural network to be trained for dynamic core integration, and then generates a dynamic core by grouping the corresponding number of switchable memories.

That is, the dynamic core generator 140 dynamically forms a core by grouping an arbitrary number of switchable memories 120 according to a layer configuration of the deep neural network, and may reconfigure the core as illustrated in FIG. 15B by grouping memories of each of layer 1 to layer 3 as illustrated in FIG. 15A.

The switchable memories 120 are allocated to map all output channels in a horizontal direction and all kernels and input channels in a vertical direction, thereby forming a variable core (A). Therefore, a computation array 20 of the dynamic core formed in this way may store an entire weight of a target layer. The switchable memories 120 allocated in this way are grouped to operate as one large computation array 20, enabling broadcasting of input and accumulation of partial sums between several macros.

Therefore, the dynamic core architecture created by the dynamic core integration method may minimize memory power consumption by accessing an input memory 10 and an output memory 30 only once. Further, in this case, only one input memory 10 and one output memory 30 may be allocated to one variable core A.

Meanwhile, referring to FIGS. 1 and 16, the dynamic core generator 140 may reconfigure the dataflow to use the output memory of the dynamic core formed for each layer of the first AI neural network as an input memory of a next layer.

Such a dynamic core combination method may further optimize variable cores for several layers of the deep neural network. The dynamic core combination method allows the output memory 41 of one layer (that is, layer i) to be shared and used as the input memory 42 of the next layer (that is, layer i+1). Therefore, the variable core generated by the dynamic core combination method may save system energy and reduce memory usage by eliminating memory task of moving data from the output memory 41 to the input memory 42.

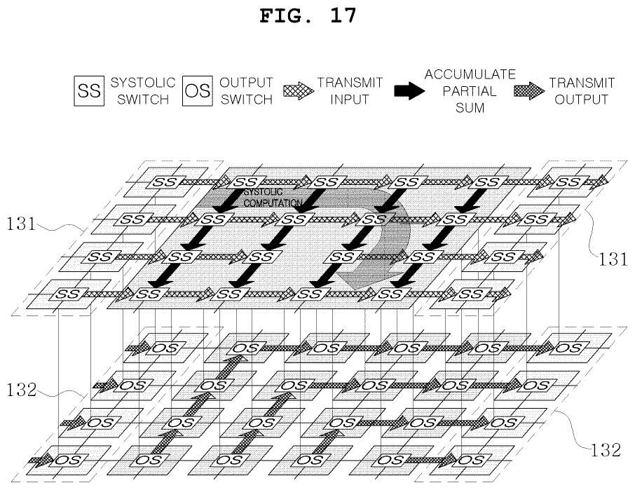

FIG. 17 is a diagram for describing a structure and an operation of a dataflow network reconfigured by the dynamic core generator illustrated in FIG. 1. Referring to FIGS. 1 and 15 to 17, the dataflow network includes the systolic link 131 for data transmission, an output link 132, and a control link (not illustrated), supports matrix-vector and multiplication by connection using the systolic link 131 to operate several switchable memories 120 as the computation array 20 in the variable core A. Therefore, input read from the input memory 10 flows along a systolic switch SS inside the variable core A within one core in a pipeline manner. Therefore, the input is reused for all output channels. In addition, the systolic link 131 accumulates partial sums in a pipeline manner using the systolic switch SS and the partial sum SIMD in the vertical direction. In this way, after accumulating partial sums in all kernels and input channels, finally generated output is transferred to the output link 132 through the output switch OS and moved to the output memory 30.

As such, the DRAM using the triple-mode memory cell of the present invention and the AI accelerator using the same are advantageous in that the sizes of the internal memory and the calculator may be varied depending on the structure and hierarchy of the deep neural network by providing a DRAM having a high degree of integration using the triple-mode memory cell, and a PIM-based processor having a dynamic core structure that may freely change connection between several memories, so that a degree of integration in the memory and area efficiency may be improved.

In addition, the present invention configures a DRAM using a triple-mode memory cell that supports a computation mode, a memory mode, and a data conversion mode by one cell and converts modes as necessary, and an AI accelerator using the same, so that a dataflow may be reconfigured according to a structure and a size of an AI neural network (so-called deep neural network) to be trained. In this way, sizes of an internal memory and a calculator are varied according to a structure and a layer of the deep neural network to form a core of a different size suitable for a structure of each layer, so that there is an advantage in that a utilization rate of the calculator and energy efficiency may be improved.

As such, the present invention may increase efficiency by combining memories as needed, which may increase computation efficiency by up to 1.81 times when compared to using a single memory. As an example, in the case of ImageNet classification using ResNet-18, when compared to a processor based on a fixed core architecture, a reconfigurable core architecture reduces memory access by up to 67.5% and improves a utilization rate of a calculator by up to 49.6%, thereby reducing overall energy consumption by 31%.

In addition, the present invention has an advantage of reducing area consumption by the analog-digital data converter by using the triple-mode memory cell structure to reuse the area used by the analog-digital data converter as a memory.

In addition, the present invention has an advantage of reducing an operation delay problem caused by refresh by synchronizing refresh of memories that operate together through dataflow reconfiguration. In other words, the refresh synchronization method according to the present invention synchronizes refresh of the memories that operate together to reduce operation delay due to refresh, thereby increasing throughput by 8.4 times in the case of ResNet-18 and 13.5 times in the case of DarkNet-19.

In addition, the present invention has an advantage of reducing power consumption by selectively operating the data converter using the hierarchical internal memory converter. In other words, the hierarchical internal memory converter of the present invention may configure a data converter using a triple mode cell to perform reconfiguring by memories, thereby improving the degree of integration by 18%, and reducing power consumption by up to 22% by operating only some logic for small data.

In addition, the present invention has an advantage of being able to improve accuracy of a PIM computation result while maintaining a high degree of integration by limiting a range of voltage used for computation inside a memory cell included in a DRAM to a voltage within a range between the ground voltage and a preset threshold voltage so that leakage current occurring in the DRAM does not affect a PIM computation result. In other words, a leakage current tolerant computing method of the triple mode cell provided by the present invention prevents leakage current from affecting a computation result even when the cell size is reduced for a high degree of integration, so that a delay time due to refresh is less than that of the overall operation, and energy consumption occupies only 19.4% of total energy.

In addition, the present invention has an advantage of being able to reduce a frequency of separate logic operations during actual deep neural network computation using distribution characteristics of input and weight by separately storing sign and magnitude values of input and weight using a 1-bit sign cell and a predetermined-bit magnitude cell and then computing both the input and weight in a memory, thereby being able to reduce energy consumption. In other words, an encoding-input encoding-weight computation method reduces an operation frequency of the input driver by up to 2.3 times and increases an operation frequency of the cell array from 2.2 times to a maximum of 5.9 times in an ImageNet classification benchmark using ResNet-18, thereby being able to reduce power consumption by up to 46.5%.

As described above, a DRAM using a triple-mode memory cell and an AI accelerator using the same of the present invention have an advantage of being able to vary sizes of an internal memory and a calculator according to a structure and a layer of a deep neural network, thereby being able to improve a degree of integration in the memory and area efficiency by providing a DRAM having a high degree of integration using a triple-mode memory cell, and a PIM-based processor having a dynamic core structure that may freely change connection between several memories using the same.

In addition, the present invention has an advantage of being able to reconstruct a dataflow according to a structure and size of an AI neural network (so-called deep neural network) to be trained, thereby varying sizes of an internal memory and a calculator according to a structure and a layer of the deep neural network to form a core having a different size suitable for a structure of each layer so that a utilization rate of the calculator and energy efficiency may be improved by configuring a DRAM using a triple-mode memory cell that supports a computation mode, a memory mode, and a data conversion mode by one cell and converts a mode as necessary and providing an AI accelerator using the same.

In addition, the present invention has an advantage of being able to reduce area consumption by an analog-to-digital data converter by allowing the area occupied by the analog-to-digital data converter to be reused as a memory by using a triple-mode memory cell structure.

In addition, the present invention has an advantage of being able to reduce an operation delay problem caused by refresh by synchronizing refresh of memories operating together through reconstruction of a dataflow.

In addition, the present invention has an advantage of being able to reduce power consumption by selectively operating a data converter using a hierarchical internal memory converter.

In addition, the present invention has an advantage of being able to improve accuracy of a PIM computation result while maintaining a high degree of integration by limiting a range of voltage used for computation inside a memory cell included in a DRAM to a voltage within a range between the ground voltage and a preset threshold voltage so that leakage current occurring in the DRAM does not affect a PIM computation result.

In addition, the present invention has an advantage of being able to reduce a frequency of separate logic operations during actual deep neural network computation using distribution characteristics of input and weight by separately storing sign and magnitude values of input and weight using a 1-bit sign cell and a predetermined-bit magnitude cell and then computing both signs of the input and weight in a memory, thereby being able to reduce energy consumption.

In the above description, preferred embodiments of the present invention have been presented and described. However, the present invention is not necessarily limited thereto, and it can be easily understood that those of ordinary skill in the technical field to which the present invention pertains may make various substitutions, transformations, and changes without departing from the technical spirit of the present invention.

1. A dynamic random access memory (DRAM) memory comprising:
a switchable PIM array including a plurality of triple-mode memory cells each operating in any one operation mode among a computation mode, a memory mode, and a data conversion mode;
a reconfigurable memory unit configured to operate as a computation control module for supporting a computation function or a buffer for data buffering depending on the operation mode of each of the memory cells; and
a memory controller configured to determine the operation mode of each of the memory cells by external control,
wherein the DRAM memory is convertible to any one of a Computation unit, a memory, and a data converter.

2. The DRAM memory according to claim 1, wherein the switchable PIM array comprises:
a memory cell a plurality of array including computation rows each formed in a unit of computation including a 1-bit memory cell (so-called “sign cell”) indicating sign and a predetermined-bit memory cell (so-called “magnitude cell”) indicating magnitude to process signals of certain bits by separation into sign and magnitude;
a global input driver configured to transmit input data or a control signal for determining the operation modes of the memory cells to the memory cell array; and
peripheral logic including ADC logic and an inter-bit parallel addition tree to control an operation of the memory cell array, and responsible for interfacing with external devices.

3. The DRAM memory according to claim 2, wherein the sign cell comprises:
a first transistor turned on/off in response to a signal of a word line to transmit a signal of a bit line into the sign cell;
a first inverter formed by a plurality of transistors connected in series between a pair of global input signals input through the global input driver; and
an amplifier connected to an output terminal of the first inverter,
wherein a local input signal is output to determine an operation mode of a corresponding magnitude cell by the pair of global input signals input through the global input driver.

4. The DRAM memory according to claim 3, wherein the magnitude cell comprises:
a second transistor turned on/off by a signal of the word line to transmit a signal of the bit line into the magnitude cell;
a second inverter formed by a plurality of transistors connected in series between a power supply voltage and the local input signal; and
a capacitor connected to an output terminal of the second inverter,
wherein the second inverter operates as any one of a multiplier, a capacitor, or a data converter according to the local input signal.

5. The DRAM memory according to claim 2, wherein the peripheral logic limits a range of voltage used for computation inside the memory cells to a voltage within a range between a ground voltage and a preset threshold voltage to prevent leakage current occurring in the memory cells from affecting a PIM computation result.

6. The DRAM memory according to claim 2, wherein the memory controller is configured to:
configure a calculator using first memory cells and configure a converter in a hierarchical memory using the second memory cells and an upper bit-ADC in a first computation row including the first memory cells operating in the computation mode and the second memory cells operating in the conversion mode,
control a word line and a bit line applied to the first computation row so that a digital signal is recorded in each of the first memory cells, and
connect output of each of the second memory cells to an internal computation line CL, and then convert a digital signal into an analog signal while changing a computation value of the computation line generated in the first memory cells using a sequential comparison method, thereby performing a control operation to detect an analog voltage.

7. The DRAM memory according to claim 6, wherein:
the memory controller stores a reference value for determining whether to use an external converter in advance,
when the input data does not exceed the reference value, upper bits of the input data are converted by the external converter, and a lower bit-ADC in the memory exclusively converts lower bits, and
when the input data exceeds the reference value, a control operation is performed to skip an operation of the external converter.

8. The DRAM memory according to claim 1, further comprising a refresh controller configured to perform a control operation so that a refresh cycle is the same as refresh cycles of other memories forming a dataflow when operating as a calculator.

9. An artificial intelligence (AI) accelerator configured to train an AI neural network, the AI accelerator comprising:
a plurality of fixed memories exclusively operating as memories;
a plurality of switchable memories each switchable to any one of a calculator, a memory, and a data converter;
a plurality of transmission links configured to connect dataflows between the fixed memories and the switchable memories SO that the dataflows are reconfigurable; and
a dynamic core generator configured to determine fixed memories and switchable memories to participate in training and an operation mode of each of the switchable memories to participate in training based on a structure and size of the AI neural network, and then reconfigure the dataflow according to a result thereof to generate a dynamic core.

10. The AI accelerator according to claim 9, wherein each of the fixed memories comprises:
a first link switch configured to form a dataflow with at least one of other fixed memories and at least one of the switchable memories under control of the dynamic core generator;
a global SRAM configured to store data necessary for the training; and
a buffer configured to buffer input/output data of the global SRAM.

11. The AI accelerator according to claim 9, wherein each of the switchable memories comprises:
a second link switch configured to form a dataflow with at least one of other switchable memories and at least one of the fixed memories under control of the dynamic core generator;
a switchable PIM array including a plurality of triple-mode memory cells each operating in any one operation mode among a computation mode, a memory mode, and a data conversion mode;
a reconfigurable memory unit configured to operate as a computation control module for supporting a computation function or a buffer for data buffering depending on the operation mode of each of the memory cells; and
a memory controller configured to determine the operation mode of each of the memory cells under control of the dynamic core generator.

12. The AI accelerator according to claim 11, wherein the switchable PIM array comprises:
a memory cell array including a plurality of computation rows each formed in a unit of computation including a 1-bit memory cell (so-called “sign cell”) indicating sign and a predetermined-bit memory cell (so-called “magnitude cell”) indicating magnitude to process signals of certain bits by separation into sign and magnitude;
a global input driver configured to transmit input data or a control signal for determining the operation modes of the memory cells to the memory cell array; and
peripheral logic including ADC logic and an inter-bit parallel addition tree to control an operation of the memory cell array, and responsible for interfacing with external devices.

13. The AI accelerator according to claim 12, wherein the sign cell comprises:
a first transistor turned on/off in response to a signal of a word line to transmit a signal of a bit line into the sign cell;
a first inverter formed by a plurality of transistors connected in series between a pair of global input signals input through the global input driver; and
an amplifier connected to an output terminal of the first inverter,
wherein a local input signal is output to determine an operation mode of a corresponding magnitude cell by the pair of global input signals input through the global input driver.

14. The AI accelerator according to claim 13, wherein the magnitude cell comprises:
a second transistor turned on/off by a signal of the word line to transmit a signal of the bit line into the magnitude cell;
a second inverter formed by a plurality of transistors connected in series between a power supply voltage and the local input signal; and
a capacitor connected to an output terminal of the second inverter,
wherein the second inverter operates as any one of a multiplier, a capacitor, or a data converter according to the local input signal.

15. The AI accelerator according to claim 12, wherein the peripheral logic limits a range of voltage used for computation inside the memory cells to a voltage within a range between a ground voltage and a preset threshold voltage to prevent leakage current occurring in the memory cells from affecting a PIM computation result.

16. The AI accelerator according to claim 12, wherein the memory controller is configured to:
configure a calculator using first memory cells and configure a converter in a hierarchical memory using the second memory cells and an upper bit-ADC in a first computation row including the first memory cells operating in the computation mode and the second memory cells operating in the conversion mode,
control a word line and a bit line applied to the first computation row so that a digital signal is recorded in each of the first memory cells, and
connect output of each of the second memory cells to an internal computation line CL, and then convert a digital signal into an analog signal while changing a computation value of the computation line generated in the first memory cells using a sequential comparison method, thereby performing a control operation to detect an analog voltage.

17. The AI accelerator according to claim 16, wherein:
the memory controller stores a reference value for determining whether to use an external converter in advance,
when the input data does not exceed the reference value, upper bits of the input data are converted by the external converter, and a lower bit-ADC in the memory exclusively converts lower bits, and
when the input data exceeds the reference value, a control operation is performed to skip an operation of the external converter.

18. The AI accelerator according to claim 11, wherein the switchable memory further comprises a refresh controller configured to perform a control operation so that a refresh cycle is the same as refresh cycles of other switchable memories forming a dataflow when operating as a calculator.

19. The AI accelerator according to claim 9, wherein the dynamic core generator determines the number of switchable memories to participate in training based on a structure and size of a first AI neural network to be trained, and then generates a dynamic core by grouping the corresponding number of switchable memories.

20. The AI accelerator according to claim 19, wherein the dynamic core generator reconfigures the dataflows to use an output memory of the dynamic core formed for each layer of the first AI neural network as an input memory of a next layer.
